(19) United States
(12) Patent Application Publication
(10) Pub. No.: US 2004/0181304 A1
(43) Pub. Date: Sep. 16, 2004

(54) Tool and fixture for measuring mechanical and electromechanical properties for IC assemblies and features

(76) Inventor: Terence Quintin Collier, Rowlett, TX (US)

Correspondence Address: Terence Quintin Collier, 1910 Sunset Hill, Rowlett, TX, 75088, US

(21) Appl. No.: 10/733,113

(22) Filed: Dec. 11, 2003

Related U.S. Application Data
(60) Provisional application No. 60/432,461, filed on Dec. 11, 2002.
(60) Provisional application No. 60/419,511, filed on Jan. 2, 2003.

(51) Int. Cl. G06F 19/00

(52) U.S. Cl. 700/121; 703/13

(57) ABSTRACT

Disclosed are the methods and tools to reliably and accurately predict and model the strength of the individual features and structures of semiconductor components. By modifying the traditional anvil/pyramidal indentors on a hardness tester, an improved method has been created to evaluate the mechanical forces on micron and submicron devices. This tool will provide a method to predict and analyze various mechanical, electrical and electromechanical states to help improve process yield, overall reliability, and design features. The modified tool will provide both a real-time process tool as well a development tool.

### PARENT CASE TEXT

This application claims priority from U.S. PTO Provisional Applications serial No. 60/432,461, filed Dec. 11, 2002 and 60/419,511 filed Jan. 2, 2003.

### TECHNICAL FIELD OF THE INVENTION

The present invention is related in general to the field of semiconductor devices and processes. More specifically, the invention relates to a method for analyzing bond pad surfaces and device structures for increased yield, structural analysis and improved device reliability.

### BACKGROUND OF THE INVENTION

A number of tools exist that provide mechanical analysis using load cells, positioning tables (or some method to adjust height) and algorithms to plot the resulting data. Among the many offerers of such tools, one family of tools is offered by CSM Instruments based out of Switzerland with offices in the United States. Unlike most others, the CSM equipment provides better force control, improve algorithms and test repeatability, reproducibility and reliability. The CSM tool also provides the capability to optically inspect the target surface features as well as the probe at time intervals during probing (as well as other times). Combing such features with the proper support features provides a tool that improves the method of analyzing various micron and submicron feature. This combination of CSM tool and support hardware also provides a mechanism to deliver multiple process improvement solutions.

Typically load cell based tools use an anvil or pyramidal type “indentor-probe” to evaluate the surface of the target. These probes provide useful data for modeling surface and subsurface hardness of materials. The targets can be a single homogenous material, a multilayered structure with discrete layers, multilayered structures with features within, alloys, etc or any combination of such. The test typically evaluates the stress-strain curves of a surface feature to demonstrate the mechanical properties of a sample. The results of probe displacement into the sample will also provide a clue as to the nature of the target specimen.

Current probe tip geometry available from CSM support traditional macroscopic and some micro hardness testing. To compete and open a market in the submicron arena, specifically on bond pads with buried structures and layers, new features and assemblage will be required to support the micron, submicron and nano-scale market. Tip geometry for these new tests plays a crucial role compared to traditional micron design or MEM's (microelectromechanical) based tooling. Being able to properly simulate and evaluate the impact of a production “probe-like” needle will be critical to not only model results but to verify test hardware and reliability. This application supports micro and smaller feature testing testing including the testing of MEM's devices. This application is not intended to cover all possible actions that one skilled in the trade could list.

To better evaluate the samples, probe geometry can be modified to properly evaluate a target sample and provide realistic results. For instance, to measure a features on a pad with 60×60 micron dimension would be ill served with a 150-micron probe. Likewise, to simulate real world of load on a broad structure, a “point” shaped probe would not extrapolate well. The applied force would be consistent with cross sectional area of the probe tip and a “point” source would prove erroneous. Regardless of probe modification, revision or adjustment, one of the critical factors is reliability and repeatability of the test equipment.

With features as small as a few microns, the high tech industry does not always have a reliable and accurate arsenal of tools to predict and model the strength of the semiconductor components. Shrinks in processing technology require thinner and thinner layers of exotic new materials as well as intricate geometry that do not readily impart ease of neither inspection nor analysis. In a number of instances, research proceeds at a slow hit and miss fashion with scientists attempting to use ad-hoc tools that are inadequate for the tasks. This invention captures the finiteness needed greatly reducing experimental error.

Ad-hoc tools that are used today can be such great sources of error due to experimental error and tolerance stack that more analysis is spent evaluating the equipment that the sample itself. Attempting to make the best of the resources at hand, designers modify and manipulate existing instruments to make the best engineering judgement to provide a continued supply of marketable materials. Unfortunately the tool that is typically used is the probe card and tester combination.

For example, the probe card tester combination can contribute to up to 50% of the experimental results. Part of the probe card error is due to the inherent error of the probe card (up to 20%) and the design. Each time a card is used, the mechanical strength changes. The strength also changes during testing as the probe needles heat. Last, since a probe card tester setup requires electrical contact before the base load can be established, it is unknown how much height has been traveled.

The height travel is also a pitfall of the tester. The tester is not meant to be used as a measuring tool, hence this ad-hoc method is error prone. The tester vibrates, oscillates and in sensitive to the test program, device, probe card and optical tool for locating the target. With experimental ranges needed within 50 microns or less, the tester can introduce up to a 30-micron error. In one example, an added factor is that bond pad might contain layers of “contaminated/corroded” surface states causing the prober/tester setup to add extra travel to make electrical contact. (This extra load add additional force and another error when accurately attempting to set a zero of first touch on the sample.)

A need to be able to measure the states of a small feature requires control, precision and repeatability. As discussed previously and as stated in provisional application 60/419,511, the surface of a semiconductor wafer can consist of many layers of materials that contribute to erroneous readings electrically and mechanically. These layers contribute to high contact resistance (CRES) and have been shown to be the root cause of errors. Having a real-time method to accurately determine (preferably non-destructive) destructively or non-destructively the layers on the surface of features will help confirm results.

With the CSM tool, probe modifications and application of both as suggested in this document, process improvements, reliability and a new development tool is the result. Understanding the features that can contribute to error also helps both with the use of this tool as well as controlling the engineer process and development to improvements. This application will show how our modified tool and processes will help predict and model damage to features for improved design and processing; how to predict surface states such as frictional coefficient between probe needle and pad and how this information can be used to increase yield, design enhanced inspection tools and improve overall product and system reliability; determine the contaminants on surfaces by using microhardness data and then using that data to model the “minerals and quasi-minerals” that prevent effective probing and reduce hardware life; and how to take the data to reverse engineer the process to improve the device design and to develop probing systems that are less likely to damage the device while increasing hardware life.

In additional to the items listed above, one of the strongest features of this tool is that it allows modeling in a fraction of the time when compared with other systems and the ad-hoc system. The ad-hoc system requires designing and ordering a probe card, writing a test program and system debug. Engineering time is required thus taking a production tool off line. Completing the experiment can take months generating marginal data at best. As a result, the test must be re-run several time to obtain any statistically relevant data. Our application on the other hand only requires hours to run the test and generates data that is repeatable and reproducible. (The tool can sense the surface with less than a gram a force rather than relying on electrical contact that might result in the addition of up to 5 to 6 grams of force.)

The present invention discloses a tool that allows incremental steps while measuring various parameters specifically load and related variations. Typically used in the macroscopic range, the load cell type tools are adopted to the micron and submicron range. Modifications to feature accessories, fixtures, assemblies and analytical wear for gathering and extrapolating data provide electrical, mechanical and electromechanical data to support engineering studies. Load control technology (or any controlled force or load) fits the model for the tools in this application solving a host of problem while providing process improvement applications as well. No off-line analysis is required which adds cycle time and yield loss.

The basic design of the tool provides easy access to view and monitor solder BUMP deformation, probe needle changes, electrical first touch, static as well as dynamic loading, needle to pad/BUMP interactions, and damage to any structures. (The current ad-hoc method does not have a capability to effectively view the “system” as it is probing.) Optical tools capture images of BUMP's under compression, die pads during probing, probing needles during probing and can include an “underview” of the pad as it scrubs. Visually, output data also provides a method to “optically” visualize interactions during the test cycle and later review of the data. (There are many more instances how images could be captured. For instance, one may want to view the probe needle at the elbow, tip or lever arm. One might also decide to view the “cobra” of a vertical needle.)

Though these are not all the results that can be obtained from such a system, these few items demonstrate an improvement in process yield, device design and reliability as well as hardware (test) improvements from the modifications suggested in this application. In addition, this application will highlight how a physical tool could be used with an EM type tool as reference in 60/419,511 (ellipsometers and spectrophotometers) to verify the actual pad morphology for improvement. This application will also provide a few embodiments of the modified probe designs to support the system upgrades. In the end, this new tool will show that it is an improvement over the current ad-hoc methods providing real time analysis to help improve and control IC process and development cycles. This application will also discuss how our technique of probe modification can be added to other systems to provide similar results.

### SUMMARY OF THE INVENTION

The present invention discloses a method for utilizing controlled loading with proper probe geometry to analyze semiconductor surfaces, features and layers. After identifying the target application, either development or in-line inspection, the proper parameters are established and the tool can be set to produce the desired results. Wafers, die, packages, structures, etc. can be specified for analysis (destructive or non-destructive) to improve control. The layer could be a die pad, a structure beneath the pad, a solder bump, the stud within the bump, a low-k layer, etc. or any feature that might not be listed but obvious to those skilled in the art.

The present invention is related to using a CSM based controlled load/displacement tool with modified probes and or using the current system, with or without modified probes, to analyze target features to use as data for process improvement, engineering development and system control. Especially those tests that require using ad-hoc designs that have high experimental error will benefit from this application.

Equally important will be those “processes” that would benefit from a tool that could monitor various parameters to suggest process improvement parameters. And equally important still, those processes and development application that would benefit from not only the improved results but the “faster” results in the goal to improve cost performance and time to market.

It is an aspect of the present invention to increase the process yield of wafer fabrication and final device fabrication, understanding the root cause of process yield loss, and to accurately model structures with this low-cost method. It is towards the completion of entire process where all the cost has been put into the device where the benefits of our application can be realized. It is also during the development process where the tool can be used to improve the development window.

It is still also during the hardware usage where huge dollars can be saved on very costly equipment and support hardware when the surfaces are improved. And still it is also during the processing where cycle time can be realized to increase throughput further reducing the cost per device.

It is one aspect of this invention to take a current “probe” needle and mount it into the fixture to compare the probe needle performance. The invention also allows usage of traditional and modified hardness probes.

Another aspect of this invention is to be able to use the data obtained to reverse engineer and improve the device design and/or suggest improvement for “test” equipment design improvements.

According to another aspect of the invention, the data is used to support technological advances and applications to reduce bond pad area by understanding the root cause of contact resistance (CRES). The area reduction helps to shrink IC chips alleviating space constraints on various electronic devices and assemblies.

According to another aspect of the invention, the tool is provided to the engineer that is repeatable and can accurately determine die fracture analysis using force or displacement as a controlling variable. No complicated test program is required for each evaluation.

According to another aspect of the invention, a tool is provided to run precision fracture analysis experiments with accuracy and repeatability.

According to another aspect of the invention, fracture analysis can be run on traditional pads, bumped wafers (flip chip), packages or printed circuit boards.

According to another aspect of the invention, optical data can be used to model and determine the “reactions and interaction” that take place with layers and probe hardware during probing.

According to another aspect of the invention, surface analysis can be run and mechanical, electrical and optical data can be taken as the samples are run.

According to another aspect of the invention, buried layers, electronic features (kelvin or 4-point probing), etc., can be used to deliver accurate results.

According to another aspect of the invention, the tool eliminates the need for “combinations” (prober/tester/card/program) that have high experimental error. Stack-up tolerance can result in 1 mil or more in error for an experiment that requires the accuracy of microns. When run in displacement mode, error less is than 1 micron!

According to another aspect of the invention, the goal is to improve processes and reliability of wafer-level probing by modeling and/or understanding the root cause of bond pad surface issues using the data generated alone or in conjunction with the results from other sources (such as a modified EM tool).

According to another aspect of the invention, data such as microhardness, coefficients of friction, grain size, etc can be used to improve the process at probe, the wafer fab, assembly or any related areas such as design. The data can also be used to improve reliability and provide a tool to rework marginal material before additional processing occurs (such as flip chip or probe).

According to another aspect of the invention, a flexible “probe” geometry is provided to realize this invention to the fullest potential. The invention provides process concepts (variable probe design) which are flexible so that they can be applied in many areas semiconductor design, processing and development.

Technical advantages provided by the invention include, but are not limited to, the ability to accurately determine the strength of IC die structures and model surface morphology. Further advantages are realized in speed, accuracy and placement repeatability for solving critical wafer development and real-time results when looking at processes such as electrical testing uncertainty. One the embodiments of the invention provides a method to allow measurement damage in-situ on traditional pads and flip chip “like” wafers. All embodiments provide the engineer, researcher or the IC designer and process owner a tool to help design and fabricate and test structures and components in a fraction of the time of traditional chip development.

### BRIEF DESCRIPTION OF THE DRAWINGS

For a better understanding of the invention including its features, advantages and specific embodiments, reference is made to the following detailed description along with accompanying drawings in which:

FIG. 1 depicts a side view of a test probe housing, or blank, typical of an in-line type probe, showing an example of an embodiment of the invention prior to adding a probe needle.

FIG. 1A depicts a reference view directly along the shaft and center-line.

FIG. 2 illustrates a cross-section view of the test probe housing that would hold typical vertical like, in-line type probes.

FIG. 3 depicts a side view of a test probe housing, or blank, typical for off-center probes such as cantilever probes, showing an example of an embodiment of the invention prior to adding a probe needle.

FIG. 3A depicts a reference view directly along the shaft and centerline.

FIG. 4 illustrates a cross-section view of the test probe housing that would hold typical off-center type probes.

References in the detailed description correspond to like references in the figures unless otherwise noted. Like numerals refer to like parts throughout the various figures. The descriptive and directional terms used in the written description such as top, bottom, left, right, first, second, etc., refer to the drawings themselves as laid out on the paper and not to physical limitations of the invention unless specifically noted. Dimensions only refer to one possible embodiment and are used here as reference dimension to suggest scale. The drawings are not to scale and some features of embodiments shown and discussed are simplified or exaggerated for illustrating the principles of the invention.

### DETAILED DESCRIPTION OF THE PREFERRED EMBODIMENTS

While the making and using of various embodiments of the present invention are discussed in detail below, it should be appreciated that the present invention provides many applicable inventive concepts, which can be embodied in a wide variety of specific contexts. Various materials and modifications can be envisioned but the conceptualization for the tool should not alter the principal discussed in this invention. It should be understood that the invention might be practiced with substrate bond pads or solder bumps, semiconductor dice and structures of various types and materials without altering the principles of the invention. Similarly, the

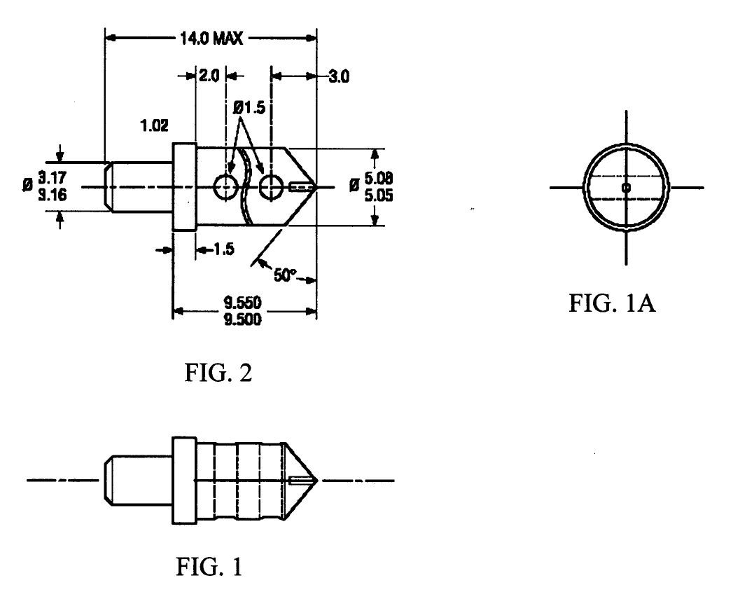

FIG. 1 shows one embodiment of the test probe housing, or blank, that is used to hold a probe needle. The method to secure the probe needle is important since any movement would skew calibration and force readings and likewise change the amount of force at the target since the contact cross sectional area would change. As such, the blank must also secure the needle in the correct alignment to reduce error. This first design would be typical of a solution to add a single probe for taking various electrical or mechanical or electromechanical readings. For example, this blank would be good for holding a probe to look at solder ball compression of die fracture analysis.

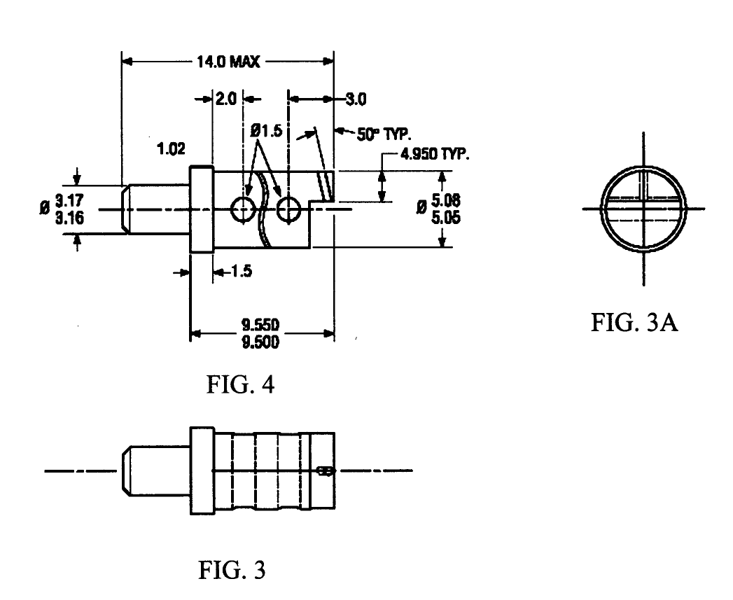

This two-piece unit allows quick changes as holes are provided to assemble and disassemble the blank to change probe types. This feature provides an advantage over the current designs as the blank is typically a one-piece unit or has an embedded diamond tip. This two piece concept provides an opportunity to quickly change and add various probe geometry minimizing cost, cycle time and expediting development and analysis. The probe itself can be any of various geometry and the cavity to which the probe can be modified to accept the design as is demonstrated in FIGS. 3, 3A and 4.

FIG. 1A shows a view looking directly down the centerline. The needle would project out of the hole in the middle in one application. The true centerline of the needle might shift depending on its design and mission. Some probing and analysis might require an off-center geometry to complete the task at hand. FIG. 1A also shows how the screw holes would hold the unit together to reduce any movement that could add experimental error.

FIG. 2 shows an exploded view to show that the probe would fit in the orifice along the centerline at the end of the blank. Reference screw holes of 1.5 DIA are also suggested. The cutaway demonstrates the two-part feature that will allow a quick change to obtain multiple read points. Note no dimension is provided in all the reference dimensions. The suggestion is that there would be a blank for some target probe geometry range. There could be a different recess to capture different geometry but the concept demonstrated in this embodiment shows how to hold and secure a given probe type.

FIGS. 3, 3A and 4 demonstrate an embodiment for a blank where the probe might come in at a right and to the centerline. This conceptualization helps with probe designs where the center of mass is not normal to the centerline of the blank or line of force. The design also covers probe needles that require force that has some moment that might include force vectors not normal to the direction of load. The dimensions are just for reference and cover one possible embodiment for the blanks and probe geometry. The dimensions of FIGS. 1 through 4 are suggested for reference for one possible embodiment to fit one possible CSM (or other suppliers) parent tool.

The basic blank/indentor design of the Vickers, pyramidal, micro-machined with flat tip or radius tip, etc., would help complete the process improvements covered in this application. By verifying surface conditions, electrical, mechanical and electromechanical properties, a number of process and develop improvements can be realized from this invention. In one embodiment, by looking at any combination of the surface hardness, friction, and probe penetration, one could use the data to suggest the material/layer on a bond pad. That information could be used to suggest that the layer caused poor electrical yield. The data can be fed back to the fabrication and the process changed to improve the pad. The data could be fed back to the electrical test team to improve hardware or environmental conditions. The data could likewise be fed to downstream processing to adjust equipment setting for the variation in surface conditions.

Similarly, by measuring the surface conditions and looking at the force required to penetrate various layers and/or fracture various layers, the designer could use this data to make a more robust structure by selecting different materials, changing the thickness or the geometry. Thus the data can be used as a feedback for design and development as well as in-process, real-time quality assurance checking. In either case, the time that can be saved is greatly improved over current methods. Yield is improved. No probe cards (reflective of the current process) are required to order. No software needs be written. No production equipment has to be taken off line to run the experiment. Costs are reduced. Overall, this one embodiment of this invention saves time, money, and resource while increasing yield and reliability.

One suggested scenario would be to look at solder ball bump deformation. The current method used by semiconductor device manufacturers involves using ad-hoc tools that are not repeatable and do not have the correct resolution. Many also require electrical contact to determine when a probe is on a target. To support the ad-hoc method, a probe card has to be ordered, production equipment moved off line and a test program written. This invention with a probe inserted into the end of FIG. 1 allows one to quickly review how much force is required to deform a solder ball on a flip chip wafer. That deformation is critical as too much deformation might damage the device and hinder additional processing. Too little deformation and no electrical contact reducing yield. This invention allows multiple bump size evaluation with one blank. This invention greatly reduces the cost and time to run such a test. Reliable and repeatable results are thus obtained since no electrical contact is required to since the surface that will tend to have a thin layer of non-conducting materials.

Another suggested scenarios would proceed as follows, insert the proper blank and probe into the CSM tool. Measure target points on the wafer bond pad. Compare the results with samples (created by this tool or others). Verify the results with previously run samples or material to suggest possible yield and performance. Supply the results to the process owner at electrical test and the fabrication site. Make necessary adjustments and complete the operation. The tool provides a quality assurance check that does not currently exist. The tool also provides an opportunity to capture images as the testing is occurring. The hardness, frictional coefficient, and surface properties (electrical, mechanical, etc) will provide a quick method to improve yield.

Many such embodiments are projected by those skilled in the art. It is the goal of this application to suggest that this tool and blank/probe combination can produce yield improvements, reliability improvements, reduced development time and provide a method to analyze structures and surfaces that have not been fully explored. All the many embodiments and process improvements that those skilled in the art might envision could not be listed and explained in this application. It is the goal to suggest a few preferred embodiments to demonstrate that the tool can be used as a method to improve design and analytical cycle time, increase yield and enhance reliability.

DISCUSSION: Incorrect BCF is a contributing cause of die fracture. Review of pad scrub patterns help determine if a card of known BCF and design will induce damage. The CVI allows the operator to rotate the probe attack angle to simulate 0, 45, and 90-degree needle angles. Accurate verification of needle BCF and scrub patterns.

Automation allows the operator to program the x-y coordinates of all the pins or to check each individually. “Sapphire Windows” or thin film Al substrates can be placed in the holder to view scrub patterns. Analysis of the scrub pattern makes the tool readily available as a verification of existing solutions or a development tool for optimizing tip design.

The tool is flexible enough to run variations in target type as well as probe types. The adjustable nature of the socket allows the engineer to optimize BCF for card design. Fracture analysis is available for a wide array of target types including BUMP's. The tool allows for verification on BUMP's as well as pads. The tool can also be modified to run experiments on small flip chip packages and sockets. Probe type is not a limitation for this flexible tool. Inserting a different socket takes less than 5 minutes and the socket is inexpensive. The engineer can model the desired BCF as the probes are adjustable in the test socket.

Probe card cost are expensive. The blank is cheap. One or more conceptualizations can be run simultaneously to optimize the best design. The tool provides a hardware verification that will save probe card companies thousands of development dollars. This invention is the only tool on the market for probe card infrastructure development, design and verification. Current manufacturing mode is to model (software), build a card, and test. If the card meets the design goals (almost never on the first try), the design is acceptable. This invention provides the resource to assemble a single needle in an assembly verifying the BCF, scrub patterns, and life of the needle documented. Adjustments are allowable without having to construct additional units.

Additional features needed such as vacuum heads, pick and place, etc. This tool is capable. The limit is the imagination. Variations of the tips allow the developer to simulate numerous floor conditions for qualification and capability analysis. This tool has the capability to run one or more probes for Kelvin analysis. Though already ahead of the competition with gram force sensitivity, adapting a “Kelvin” tip allows the analyst to model the exact force required to penetrate barrier layers for electrical contact. When required to evaluate and isolate contaminant and corrosive layers on BUMP's or pads, this invention is the tool. This feature could also be used for electro-migration (EM) studies during package development.

Finally, there are still other embodiments that exhaust this paper. This invention can show the probe needle as it scrubs the pad, in differing view, top, bottom or side. Show the probe needle as it flexes at the radius, along the beam or at the epoxy. Shows if tiers flex differently. How one type probe, the Cobra, on a vertical needle truly bends. As predicted or on multiple bends. Shows if there is an x-y motion on vertical needles and provides an opportunity to view the needle in motion while looking at the failure curve to predict needle life and modulus allowing the developer can determine if an effect is due to needle or fracture.

CURRENT METHODS: Current methods to check a number of the parameters above use an electrical probe card, tester and prober. These systems have variance that can impede the development and release of product on time. (This invention also provides the owner the ability to check the spring constant of a given probe card.) The system can have an error as much as +50 to +100 microns yet be used to attempt to evaluate systems that require steps as little as a tenth of a micron. Those same systems may be attempted to use to derive force data yet the systems are not linear and are approximations at best. Effects of deformation on solder bumps, breaking forces on dielectrics, etc can now be analyzed with tools developed in this project.

Hit and Miss is simply that. A number of designers do not have the tools to evaluate systems so they build, test and rebuild until the desired expectations are obtained. The tools here will provide a useful process to obtain “real” data that can be incorporated into prototype designs reducing the number and time to yield an acceptable standard. The data can be used to predict reliability results to electrical achievement, as well as mechanical performance.

Focused Ion Beam. FIB can be a form of hit and miss. Samples are prepared, evaluated electrically and mechanically then destructively evaluated (using FIB) to determine how and why layers, materials, etc interacted. Such cross sections can show root cause by a detailed analysis or incorporation into a tool that allows one to evaluate electromechanical testing simultaneously. Unfortunately such a tool could add unknown variables and interactions into the test. It's best to evaluate then test on a similar level to simulate production. FIB has the disadvantage of too small and an electromagnetic field that can influence performance.

Atomic Force Microscope. This submicron tool can be used to evaluate layers and features on the atomic level. Such result may prove beneficial but may be unrealistic due to scale. Just as the macroscopic tools are inadequate for the micron and submicron, atomic force level (nanometers and angstroms) may be orders of magnitude to small to provide useful and beneficial data. Other related tools include variations in surface microfriction with a lateral force microscope (LFM), orientation of magnetic domains with a magnetic force microscope (MFM), and differences in elastic modulus on the micro-scale with a force modulation microscope (FMM). A very recent adaptation of the SPM has been developed to probe differences in chemical forces across a surface at the molecular scale. This technique has been called the chemical force microscope (CFM). Though the AFM and STM can used to do electrochemistry on microscale, the data may not extrapolate well to mechanical performance.

REQUIREMENTS: A number of stages in the design and manufacture of “components” require evaluation of mechanical and electrical properties. Knowing the strength of these materials in thin, micron and submicron layers is instrumental to the design and development of the die, package and electrical test of product. Traditional mechanical testing tools are orders of magnitude to large to accurately evaluate critical properties. The repeatability of the “current test” tool(s) will also come into question as the dimension of the feature may fall outside the resolution of the tool.

SOLDER BUMP DEFORMATION:_Packages (and die that serve as the package such as chip scale packages, CSP), have solder balls that are subject to deformation during the process. This deformation can lead to electrical failure and/or poor reliability in the field. Unfortunately the bumps can be as small as 60 microns (or more) with a pitch of 100 microns (or less). Typical tools are both too large to accurately measure one bump without impacting adjacent bumps thereby skewing the data. The probe “tips” currently used do not simulate production nor is there a demonstrated flexibility and sensitivity to such small geometry.

SOLUTION: Suggest using this invention with a “modified probe” tip similar to the “pin” geometry used in typical vertical probe cards. The cylindrical pin simulates the contact that a solder ball/BUMP would encounter in production. This pin geometry also allows a more parallel test of the surface of the bump. Other technology that uses “blades” could be demonstrated as well by changing the tip design. The CSM tool provides the z-travel that is typical of testers and characteristic of application.

DIELECTRIC AND OTHER LAYER EVALUATIONS: The circuitry that makes up today's IC die and packages can be in one or more layers on the surface or buried within the structures. The strength of these structures can be predicted and modeled with finite element analysis. This “guestimate” allows the designer to suggest a dimension and tolerance range to yield the desired electrical results. Assemblies may then be subjected to macroscopic electrical and mechanical reliability test to evaluate performance. Optimization may require many such tests until the desired outcome is produced. Goals may be as simple as to assure the few orders of magnitude difference in strength required for electrical test does not damage underlying layers.

SOLUTION: Design a tool that with a tip that has a small feature. One such design could be similar to the vertical column test cards. (Cantilever, MEM's or any number of probing “tip” designs currently available or future designs.) One such column could be micron geometry to simulate production and manufacturing at various stages. For example, a 100-micron diameter column simulates a typical probe card contact on a

CSP bump. This data provides the detail of how much force is required to deform the bump as well as any potential damage to the structures below. The load cell technology of the CSM provides more accurate z-travel to correctly evaluate true force values per incremented motion. Reverse engineering allows those numbers to be extrapolated to suggest ranges of z-travel for electrical test. Other geometry allows a broad evaluation of supplementary parameters. Another addition such as a x-ray reflectance (XRR) would help measure CTE properties as well. The combination tool should prove most useful.

Looking at the frictional forces between the surfaces also provides useful information. Know values can be researched or created from test samples and compared to the current yield. The results can be used to check the status of the current process as well as suggest real-time changes to hardware to assure a good yield with minimal device damage. The data could also be used to suggest a rework before any additional processing dollars are added.

METAL STACK EVALS: Metal stack and other materials impart stresses to packages and die that are modeled. Typically a device has to be packaged to simulate the true stresses that combined to produce the resultant forces resulting in failure or optimized performance. This test can require hundreds of die, thousands of hours and wasted raw materials.

SOLUTION: Performance can be simulated at various levels by determining if the die or package needs analysis. Incorporating the “assembly” into a housing and fixturing allows one to separate the die from the package and likewise the package from the die. XRR also helps provide detail on micron scale dimensional and lattice changes. Evaluating either alone or both in a system is within the scope of this invention. Supplying the forces that reflect CTE mismatches, temperature and heat produce when copper, silicon, polyamide, etc combine in a partial or finished assembly, knowledge can be gained and the savings in material and time are not exaggerated.

CHIP SCALE PACKAGE STRESS: Chip scale packages (CSP) are projected to become one of the primary package types in the market within 5 to 8 years. As the package becomes the limit to shrinking technology, CSP's are a must to propel technology to the “micron” scale. Tools used to test these packages incorporate controlled displacement tooling and fixturing on macroscopic parameters such as ball shear, package shear, elastic modulus, etc. With CSP, the “silicon” die becomes the substrate and source of electrical contact to the outside world. Combining modeling and ad hoc tools with trial and effort provide initial data to bring products to market with goals to improve the package at latter dates.

SOLUTION: A modified CSM tool with the correct submicron assemblies, attachments and features would prove quite useful. For example, ball shear strength may prove more reliable as the tip and geometry are more in line with the feature size and geometry. The ability to increment stages in a micron “step” mode to check “force” parameters will prove beneficial. More important, modeling the effects of device performance to constraints not only from the CSP but also to contributions from the outside world, the appropriate geometry and tools are needed. Micron based tooling, fixturing and detection devices are a must. A CSP with underfill has at minimum the effects (such as CTE) of the package, the underfill, the secondary substrate (PCB for example) as well as the CSP itself. Flexural modulus, overall stress and life cycling may all be simulated, versus modeled, with the proper fixture that can impart a xyz force on the system. A platum that can provide a source for heat and electrical verification adds one additional prospect to an Instron-like tool.

ELECTRICAL TESTS: Fairly straightforward, a number of tests require the later or simultaneous verification of electrical requirements. As a number of current systems are macroscopic in nature, there tend to be constraints in running an electrical source and detection system.

SOLUTION: Electrical test can be accomplished by designing the micron/submicron-based tool to permit the sourcing of electrical detection means. In some cases the tool may be as simple as using conductive probe(s). Electrical performance in time, after applied stresses, and based on varying materials (type, structure, crystal/amorphous, specified layer, etc) among others can be ascertained concretely with an this tool and the proper gage. One example would be to check the effects of the stress on an oxide layer and the resulting impact on leakage or other electrical properties. A second could be the effects of stress on the intermetallic separation of metals and alloys under a given stress. One additional test might suggest a 4-point probe to determine the actual CRES of a surface layer.

PROBE CARD DESIGN: Current methods of card design use software to model design and geometry. The “model” is then extrapolated and a card constructed. This model is used for many such card designs, specifically cantilever type. The resulting error is from modeling is weighed against fabricating numerous cards to verify final results. Of course models only approximate the final product. Errors are passed along to the final design unless the designer is willing to assemble large numbers of finished units to adjust the results.

SOLUTION: This invention allows “adjustments” of the needle design without building a completed unit (probe card). This adjustment allows the software model to be evaluated in a timely and cost effective method. The data not only helps correlate the software to real results, but also allows fine adjustments to the draft for a final design. Unlike current methods, the tool also has the advantage that it can measure contact force in-line without requiring a second tool.

SOLUTION: This invention provides measurement capability of contact force. The current method requires measurement using an off-line tool that is expensive and unreliable. This tool has the advantage that is can be calibrated rather simply allowing quick measurements of contact force and probe card scrub patterns. This data can be used to measure needle material properties at time zero, after use, at various temperatures, electrical loads, evaluate material interaction, environmental impact, etc.

RISK ASSESSMENT: Skilled project managers proceed through a structured process that involves risk assessment to determine not only the viability of a project but also to identify the weak links. Since the number and types of tools are limited in scope, this invention and the associated process control steps with the proper fixtures, accessories and features can provide useful information to the skilled project manager. Having these tools could save weeks if not months off the development cycle time.

BOND PAD CORROSION: Every IC wafer must be electrically tested. Unfortunately Al-alloy bond pads suffer contamination and corrosion reducing test probe efficiency and yield. The aluminum layers are combinations of various oxides, fluorides, and others depending on the process chemistry. A process engineer must understand the causes of these layers or develop solutions to remove these layers of corrosion. An uncontrolled process with surface corrosion is process limiting and yield suffers. By capturing the root cause and modifying the surface to adjust for the barrier layers, the number of touchdowns can be extended thus improving yield and hardware life. The hardness or softness of the target layer can be reviewed and process improvements suggested to adjust the layer so hardware life can be extended or process yield and device reliability can be gained. The surface morphology of the pad will show a direct relation to various mechanical properties such as frictional force, hardness, grain size, electrical properties, etc all of which can be determined to improve the process.

CRES: The barrier layers result in contact resistance (CRES). CRES is the measured impedance between the probe tip (or socket) and the electrical outputs of the device under test (DUT). The typical impedance range of the metallics used for probes, sockets, pads and bumps have values in the milliohm range. With continuous probing or insertions, contaminants build up causing the impedance to rise beyond time zero values. This rise in impedance results in poor contact, electrical fails (opens, speed related fails, Vth, Io, etc), and reduced life of probe hardware. The test hardware must be cleaned each time the CRES reaches a critical value. Without cleaning, increased test time, process bottlenecks and assembly issues become drains on resources and profit. Unfortunately the cleaning reduces the life of the probe hardware. CRES is overcome by continuously cleaning or adding extra force to go below the corroded crust. The CRES root cause can lead to die fractures, yield loss, assembly issues and poor reliability.

WAFER PAD PROBING: Aluminum corrosion takes the form of oxides, fluorides, and complex compounds. In the addition to the native oxide that would form on aluminum, these “compounds” are the result of processing the wafer and backend assembly operations such as saw. As a native oxide, it is economically impossible to prevent the formation of the aluminum oxide. But the reactive by-products that result in crystals, quasi-crystals, hydrates and the chicken soup of other stuff on the surface are where this invention has promise. The goal of the process owner should be to minimize the thickness of the native material and by-product oxides. But first the owner needs to identify and determine the root cause of the problem. This invention helps identify problem surfaces and can help isolate the material in the layer that can lead to root cause analysis and control.

IMPACT ON YIELD: The impact of CRES on yield will be reduced probing efficiency, yield loss, increased cycle time at test, and possible die damage. Die damage occurs when the machine is adjusted to “dig” deeper into the aluminum pad to make electrical contact. Damage might also occur as the owner “reprobes” failed die to capture additional yield. Each case can result in exceeding spec limits for surface scrub damage and might also damage under lying IC structures as well. The yield on for the given process might also take a turn for the worse as wire bonding on the contaminant layers might prove difficult due to the scrub mark, contaminant layer, and the reduction of alloy available for the gold wire bond.

ROOT CAUSE: As stated earlier, an analysis of the process helps identify where the corrosion occurs. Without this analysis, the process might appear good one day and marginal the next. To obtain process control and stability, solutions need to be in place that control or monitor contamination at critical stages. This invention provides a real-time, as well as developmental tool, which can provide useful data on a number of parameters that will lead to process control. In the in-line mode, this invention provides real time feedback to the process owner allowing the owner to rework the material prior to additional processing and imparting permanent damage to the material. This tool also helps the process owner determine how much force the die can withstand without damaging underlying structures.

CSP PROBING: CSP probing is dissimilar in that flip chip BUMPS are the probe sites. As a result, a different probe needle is used to make electrical contact. (Prior to flip chip processing, the invention could be used to assure the bond pads or layers are in good condition. For example, A surface layer could add an unknown impedance causing yield loss or poor processing.) There are also different contaminants that impact performance. CSP CONTAMINATION: With flip chip and CSP probing, flux residue and oxide formations are the typical sources that contribute to poor CRES and decreased yield. In the alpha stages of process design, residue from flux material can cause CRES to rise after probing the first site. Such poor process stability is acceptable when designing the process in the early stages.

As the process matures to a state of stability, the increase CRES is easily tracked, identified and solutions implemented to bring the process into control. CRES might account for a small percentage of yield loss in a stable process but a review by the process manager can identify the last sources of the problem to capture the remaining percentage points. Simple DOE's can also be generated to review the impact of flux residue on CRES and yield.

This invention helps by determining how much force is actually required to deform a solder ball and to make electrical contact. Any additional force might be the result of out of control processes. The invention also helps to determine the deformation force for various solder alloys, ball geometry and design and how much of the force transfers to the structures below the solder bump. The invention also provides an opportunity to view a bump as it is probing to witness deformation of the bump and needle. The invention also allows the process owner to run individual needle evaluations to determine the correct design and alloy to provide optimum hardware design at room, cold and high temperature.

IMPACT ON YIELD: With the increasing amount of overtravel necessary to make electrical contact, additional damage occurs to structures. With additional damage, yield suffers. Controlling the process by implementing the correct hardware, tooling and cleaning settings helps the process by improving yield at both front and backend; saves probe card life; increases the number of touchdowns between cleans; and saves test cycle time up to an hour or more.

IN-LINE QA: Both die pads and bumps have requirements for probing that are directly related to the mechanical properties and probe force. The corrosion on a bond pad will directly influence the CRES and resulting yield. To take advantage of this knowledge, the invention can review the pad properties in line and provide feedback to the test engineer and fab. The savings to the company show an immediate increase. The proper insertion or prober force has a direct influence on CRES, too little force, poor electrical contact; too much force, damaged hardware and devices; and too much force, lost yield at flip chip assembly.

How to determine the actual amount of force required to deform the bump or pad. The prober-probe card setup can take months, consume engineering resources and equipment time. The prober-probe card method is also inaccurate. The invention provides the amount of probe displacement for a given force, the amount of deformation based on an applied load, the amount of deformation after repeat testing, a summary demonstrating the maximum deformation occurs on the first probe sequence and summarizes the accuracy of the rated Probe BCF. This tool and process can also be used to review both bumps and die pads for low-k fracture analysis as well.

### CONCLUSION

This tool can be used in a number of variations to deliver solutions to IC front and back end, probe card manufactures, development labs, material analysis teams, etc. This list is not meant to be all-inclusive as individuals skilled in the arts could suggest additional applications beyond the items listed. The tips and the process to use the tips on the CSM become the fundamental basis for this patent.

For example, an immediate use could be to use the tool to study the impacts of how a probe needle interacts with the material surfaces to analyze material interactions, frictional effects, crystal and amorphous interactions. A second would be the ability to modify the tip to allow adjustments in “needle” length and geometry to quickly verify modeling data. The same tool could be used at an end user to verify a number of probe card parameters that would otherwise have an unverifiable set of data points.

This application does not limit the geometry of the blanks to support various probe tip designs to the figures attached in this patent. Many probe needles exist to electrically test semiconductor devices. The flexibility to capture blank design to support various probe tip designs in an important feature of this application. The process improvement obtained by using the tool in various modes will be dependent on blank and probe tip solutions. The tip could be designed to support a number of current and future shapes, geometry, forces, loads, and electromechanical studies. The tool/tips setup readily allows for controllable placement, data verification and repeatability. As probe cards, and the need to gather “changing” data, the tips can be modified to support.

These examples are but a few of the many possible embodiment envisioned by this invention. Those skilled in the art might think of many more that would exceed the length of this application. This application listed but a few and explained the root cause of the problems as well as how the invention would address and help to solve from a process-engineering stance.

What is claimed is:

1. A method for improving load and/or displacement controlled tools and systems for modeling and simulation for semiconductor devices comprising:
modification of the indentor blank;
improving the process to add different probe needles; and
controlling the method of the applied force or displacement.

2. The method according to claim 1 wherein the indentor blank comprises an orifice to accept a probe needle.

3. The method according to claim 1 wherein the indentor blank has a flat to allow bonding of a probe needle.

4. The method according to claim 1 wherein the probe needle is securely attached to the blank.

5. The method according to claim 1 wherein the indentor blank is two or more parts.

6. The method according to claim 1 wherein the indentor blank allows
more than one type probe geometry.

7. The method according to claim 1 wherein the indentor blank design allows adjustment of the probe length.

8. The method according to claim 1 wherein the indentor blank is designed such that the centerline of the needle is not in the centerline of the indentor blank.

9. The method according to claim 1 wherein the force applied by the probe in not in the centerline of the indentor blank.

10. The method according to claim 1 wherein the force and displacement applied is not normal to the centerline.

11. A method for improved real time process control, device and package designs, enhance semiconductor support systems and better device reliability comprising;
using load and/or displacement controlled tools and features;
capturing data for modeling and simulation; and
implementing change based on the results.

12. The method according to claim 11 is to use an in-line load and/or displacement controlled tool with indentor blanks and probe needles to gather real-time electrical, mechanical and/or electromechanical data.

13. The method according to claim 11 where the tool is used to simulate electrical probing, mechanical stresses and/or environment factors on one or more target specimens.

14. The method according to claim 11 where the tool generates surface morphology data.

15. The method according to claim 11 where the tool is used to verify the strength of the probe needle.

16. The method according to claim 11 where the tool is used to review probe material to target material interactions.

17. The method according to claim 11 where the tool is used to capture optical images of the probe or target for evaluation and improvement.

18. The method according to claim 11 where the tool is used to analyze the deformation or fracture of a target site.

19. The method according to claim 11 where the results are used to analyze the surface and subsurface layers to suggest improvement.

20. The method according to claim 11 where the tool can be used in-line to provide real time feedback to process owners.
